(19) United States
(12) Patent Application Publication
(10) Pub. No.: US 2003/0079955 A1
(43) Pub. Date: May 1, 2003

(54) Power transmission system for an automatically engaging four-wheel drive vehicle

(76) Inventor: Il-Soo Kim, Seoul (KR)

Correspondence Address: Pennie & Edmonds, LLP, 3300 Hillview Avenue, Palo Alto, CA, 94304, US

(21) Appl. No.: 10/167,804

(22) Filed: Jun. 11, 2002

(30) Foreign Application Priority Data
Oct. 25, 2001 (KR) 2001-0065871

(51) Int. Cl. F16D 28/00; B60K 23/08

(52) U.S. Cl. 192/84.6; 192/84.7; 192/93 A

(57) ABSTRACT

The present invention relates to a power transmission system for an automatically engaging all-wheel drive vehicle that efficiently realizes all-wheel drive according to driving conditions. The power transmission system includes a rotary coupling mounted on a power transmission member for transmitting power that is output from an engine to front and rear wheels, the rotary coupling selectively transmitting the power to one of either the front wheels or the rear wheels, or to all four wheels. The rotary coupling includes a housing connected to an input member; a hub shaft connected to an output member; a multi-plate clutch mounted between the housing and the hub shaft; and a pressure assembly operated according to driving conditions to control the multi-plate clutch.

### FIELD OF THE INVENTION

The present invention relates to a power transmission system for an automatically engaging all-wheel drive vehicle, in which all-wheel drive is more efficiently engaged such that the benefits of sending power to all four wheels may be easily realized.

### BACKGROUND OF THE INVENTION

Most vehicles have a two-wheel drive structure in which power is transmitted to either the front wheels or rear wheels. However, some vehicles are equipped with a four-wheel drive or all-wheel drive system that allows for the transmission of power to all four wheels. Four-wheel drive generally refers to manually engaged, temporary power to all four wheels, while all-wheel drive generally refers to permanently engaged or automatically engaged power to all four wheels. The advantage of driving all four wheels is better transmission of engine power to the road surface such that all-weather and all-terrain-driving performance are greatly enhanced.

As described above, the transmission of power to all four wheels is temporary with four-wheel drive. That is, power is transmitted to two wheels unless the four-wheel drive capability is engaged by the driver using a four-wheel drive transfer case, thereby realizing better performance on rough terrain and/or in bad weather conditions. In all-wheel drive vehicles, power is transmitted to all four wheels either permanently or automatically as needed.

The disadvantages of both systems include a complicated structure, increased vehicle weight, a higher center of gravity for the vehicle, and increased costs. Also, acceleration performance is diminished and fuel consumption is increased when four-wheel drive is engaged.

On the other hand, four-wheel drive and all-wheel drive provide enhanced cornering performance, improved stability when driving in a straight path, excellent traction in bad weather and rough terrain conditions, a superior ability to climb and descend off-road hills with a steep gradient, and greater stability in high-wind conditions. Although four-wheel drive and all-wheel drive are used mostly in trucks, jeeps, and other similar vehicles, it is expected that the application of the four-wheel-drive capability will become increasingly common in regular automobiles.

With reference to FIG. 1, in a power transmission system for an automatically engaged all-wheel drive vehicle, torque generated by an engine 2 undergoes shifting for reduction or direct transference by a transmission 4 and then drives front wheels 6. Part of the engine torque is taken from a front wheel differential 8 for transmission to a rear wheel differential 12 through a propeller shaft 10 to thereby drive rear wheels 14. Further, a rotary coupling 16 is mounted on a center portion of the propeller shaft 10 and is engaged when there is a difference in rotational speeds between the front wheels 6 and rear wheels 14.

A conventional rotary coupling 16 is shown in more detail in FIG. 6. A front propeller shaft 100 and a housing 102 are connected. Also, within the housing 102, friction members 106, which are mounted between a plurality of plates 104, and a rotor 108 are connected to a rear propeller shaft 110.

Further, a piston 112 is provided between the rotor 108 and the set of friction members 106 and plates 104. The piston 112 is moved in a direction toward the friction members 106 and plates 104 such that these elements come in close contact. When this occurs, the front propeller shaft 100 and the rear propeller shaft 110 are interconnected. The space between the piston 112 and the housing 102 is filled with silicon oil 114 such that the rotor 108 is fully submerged in the silicon oil 114.

With the above configuration, two-wheel drive occurs when driving in normal conditions. However, if there is a difference in rotational speeds between the front wheels and the rear wheels such as when quickly accelerating on a wet road surface, the rotor 108 and blades attached thereto rotate such that the silicon oil 114 pushes against the piston 112 to move the same toward the plates 104 and friction elements 106. A clutch realized by the plates 104 and friction elements 106 is therefore engaged such that the front and rear propeller shafts 100 and 110 are interconnected, thereby realizing all-wheel-drive capability.

However, with the conventional rotary coupling structure described above, all-wheel drive is not realized unless a difference in rotational speeds between the front and rear wheels occurs. Further, operation of the system depends only on the force provided by silicon oil. Accordingly, the all-wheel drive capability is engaged only in extreme circumstances where the drive wheels have lost traction and are spinning. Therefore, the conventional system as described above may only be used in light vehicles.

### SUMMARY OF THE INVENTION

The present invention provides a power transmission system for an automatically engaging all-wheel drive vehicle, in which all-wheel drive is efficiently realized by a rotary coupling that is electronically controlled. In a preferred embodiment, the present invention comprises a rotary coupling mounted on a power transmission member for transmitting power that is output from an engine to front and rear wheels. The rotary coupling selectively transmits the power to one of either the front wheels or the rear wheels, or to all four wheels. The rotary coupling preferably comprises a housing connected to an input member; a hub shaft connected to an output member; a multi-plate clutch mounted between the housing and the hub shaft; and a pressure assembly operated according to driving conditions to control the multi-plate clutch.

In an alternative preferred embodiment of the invention, a clutch is disposed between an input member and an output member. The clutch may be a multi-plate clutch. A piston acts on the clutch for engagement thereof. The piston includes a piston pressure surface opposite the clutch with at least one indentation formed therein. A pressure member faces the piston pressure surface with at least one corresponding indentation formed therein. A spherical member is disposed in the indentations between the piston pressure surface and pressure member. A rotatable control assembly cooperates with the pressure member for rotation thereof in response to a control signal. Rotation of the pressure member forces the spherical member out of the piston pressure surface indentation whereby force is applied to the piston to engage the clutch and permit power transmission from the input member to the output member. In a further preferred embodiment the rotatable control assembly includes a driven gear acting on the pressure member and a pinion gear driven by a motor cooperating with the driven gear.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view of a power transmission system and related elements for an automatically engaging all-wheel drive vehicle;

FIG. 2 is a sectional view of a rotary coupling according to a preferred embodiment of the present invention;

FIG. 3 is a schematic view of the rotary coupling of FIG. 2;

FIG. 4 is a schematic view of elements used in operation of a preferred embodiment of the present invention;

FIG. 5 is a schematic view of the rotary coupling of FIG. 2 shown in an engaged state; and

FIG. 6 is a schematic view of a conventional rotary coupling.

### DETAILED DESCRIPTION OF THE PREFERRED EMBODIMENTS

Preferred embodiments of the present invention will now be described in detail with reference to the accompanying drawings.

As described above, in a power transmission system for a vehicle with all-wheel-drive capability, torque generated by an engine 2 undergoes shifting for reduction or direct transference by a transmission 4, then drives front wheels 6. Part of the engine torque is taken from a front wheel differential 8 for transmission to a rear wheel differential 12 through a propeller shaft 10 to thereby drive rear wheels 14. Further, a rotary coupling 16 is mounted on a center portion of the propeller shaft 10 to compensate for differences in rotational speeds between the front wheels 6 and rear wheels 14. Since the rotary coupling 16 is a massive element, it is rotatably supported on a vehicle frame 48.

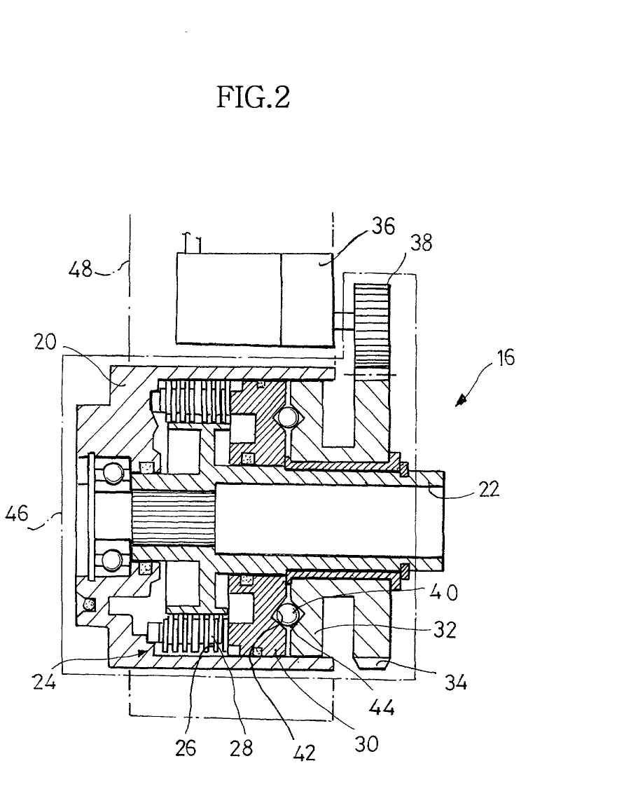

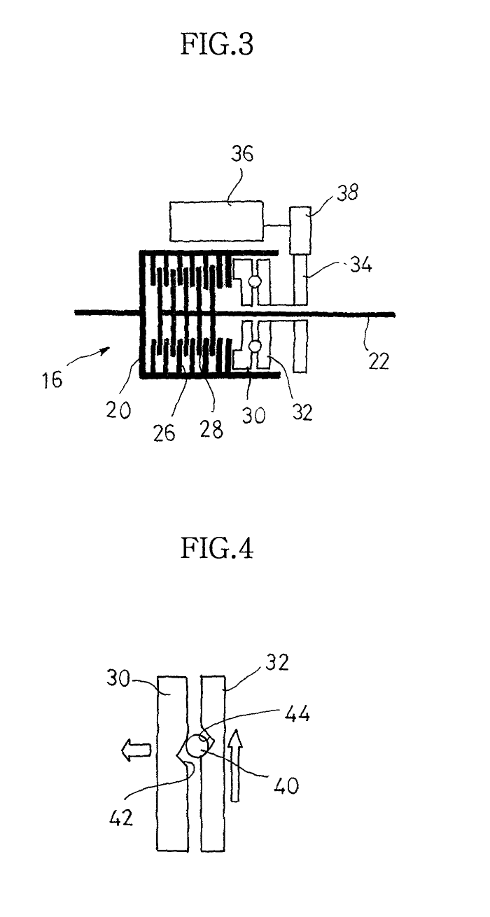

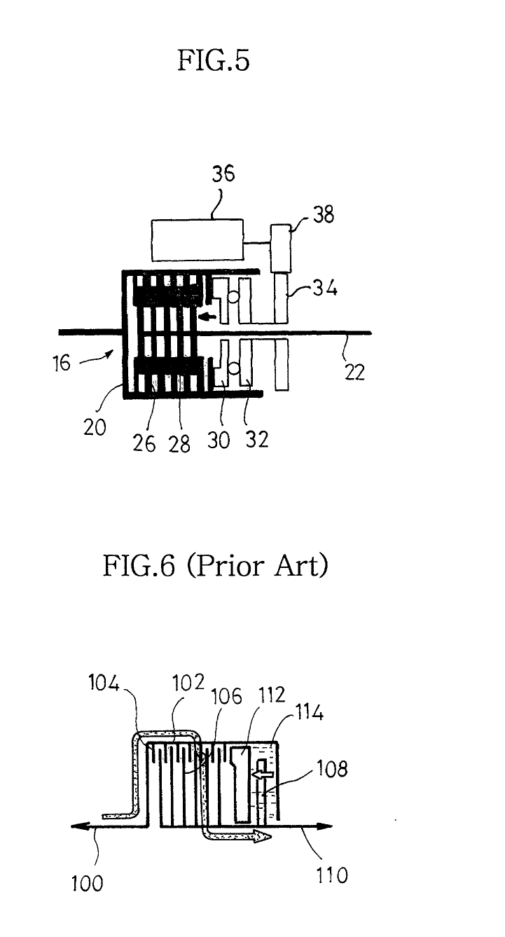

With respect to the rotary coupling 16, with reference to FIGS. 2 and 3, a multi-plate clutch 24 is mounted between a housing 20, which is connected to an input member, and a hub shaft 22, which is connected to an output member. That is, a plurality of clutch plates 26 are mounted in an inner circumferential gear portion of the housing 20, and friction members 28 are mounted between the clutch plates 26 in an outer circumferential gear portion of the hub shaft 22. Also, a piston 30 is mounted on the hub shaft 22 for selectively closely contacting the clutch plates 26 to the friction elements 28.

In a preferred embodiment of the present invention, a pressure device 32 is mounted adjacent to the piston 30 opposite the clutch plates 26 and the friction elements 28. The pressure device 32 selectively applies a force to the piston 30 in a direction toward the clutch plates 26 and the friction elements 28. The pressure device 32 is rotatably mounted on the hub shaft 22.

A gear assembly 34 is mounted to a side of the pressure device 32 opposite that of the piston 30. The gear assembly 34 is meshed with a pinion 38 of a motor 36, which is fixed to the vehicle frame 48, such that the pressure device 32 is rotated according to the operation of the motor 34.

Further, a clamping ball 40 is mounted between the pressure device 32 and piston 30. The clamping ball 40, with reference to FIG. 4, is inserted in indentations 42 and 44 formed on facing surfaces of the piston 30 and the pressure device 32. A plurality of the indentations 42 and 44 are provided, and the plurality of the indentations 42 and 44 are disposed tangentially with respect to a rotating axis of the piston 30 and the pressure device 32. When the indentations 42 and 44 are positioned directly across from one another, the clamping ball 40 is maintained in a space formed between the indentations 42 and 44. However, when the pressure device 32 rotates by a predetermined angle, the clamping ball 40 is forced out from the space between the indentations 42 and 44. When the clamping ball 40 is pushed out of the space between the indentations 42 and 44, the clamping ball 40 exerts a force on the piston 30 in a direction toward the multi-plate clutch 24 to engage the same.

A case 46 covers the rotary coupling 16 in such a manner as to not interfere with the rotating action of the rotary coupling 16. The case 46 is mounted to the vehicle frame 48. Since the mounting of the case 46 to the vehicle frame 48 and the structure of the case 46 to allow the free movement of the rotary coupling 16 are conventional, a detailed description will not be provided.

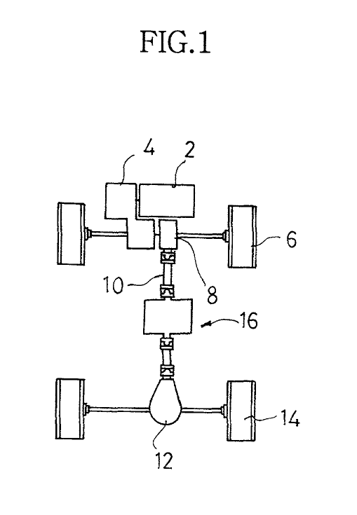

With the rotary coupling 16 structured and operating as described above applied to the system of FIG. 1, FIG. 3 shows a state where the rotary coupling 16 is not activated for its coupling function. In this case, two-wheel drive is effected. However, when an electronic control unit (not shown) determines that all-wheel drive is required based on signals received from sensors mounted at various locations of the vehicle, the electronic control unit drives the motor 36. The sensors may include sensors for detecting rotational speeds of the front and rear wheels, and sensors for detecting rotational speeds of the front and rear propeller shafts. The electronic control unit compares these signals to determine if there is a difference in rotational speeds of the front and rear wheels, in which case the motor 36 is driven to thereby result in the operation of the gear assembly 34.

As a result, the pressure device 32, which may be integrally formed with the gear assembly 34, is rotated such that the clamping ball 40 receives a force to dislodge the same from within the space between indentations 42 and 44. When the clamping ball 40 is removed from within the space between the indentations 42 and 44, a force is applied by the clamping ball 40 to the piston 30 to move the piston 30 toward the multi-plate clutch 24. With the movement of the piston 30 toward the multi-plate clutch 24, the clutch plates 26 and friction members 28 of the multi-plate clutch 24 are closely contacted as shown in FIG. 5 to engage the multi-plate clutch 24. Therefore, power is also transmitted to the rear wheels.

In the all-wheel-drive state, the electronic control unit continues to operate the motor 32 as needed (i.e., as determined to be needed from the input signals) to maintain the four-wheel-drive operation. When it is determined that four-wheel-drive operation is no longer needed, the electronic control unit cuts off control current to the motor 32 such that the rotary coupling 16 returns to a normal, two-wheel drive state.

In the present invention described above, the rotary coupling is controlled by the electronic control unit when it is determined by the same from specific conditions that four-wheel-drive operation is needed. As a result, an all-wheel-drive capability is efficiently realized.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A power transmission system for an automatically engaging all-wheel drive vehicle comprising a rotary coupling mounted on a power transmission member for transmitting power that is output from an engine to front and rear wheels, the rotary coupling selectively transmitting the power to one of either the front wheels or the rear wheels, or to all four wheels, wherein the rotary coupling comprises:
a housing connected to an input member;
a hub shaft connected to an output member;
a multi-plate clutch mounted between the housing and the hub shaft; and
a pressure assembly electrically controlled according to driving conditions to control the multi-plate clutch.

2. The system of claim 1, wherein the pressure assembly comprises:
a piston selectively engaging the multi-plate clutch;
a pressure device mounted adjacent to the piston on a side of the piston opposite that of the multi-plate clutch, the pressure device selectively applying a force to the piston in a direction toward the multi-plate clutch;
a motor driving a gear assembly according to control by an electronic control unit; and
a clamping ball mounted between the piston and the pressure device, the clamping ball applying a force to the piston in the direction toward the multi-plate clutch to move the piston, the clamping ball performing this operation according to a rotation of the pressure device.

3. The system of claim 2, wherein the clamping ball is inserted in indentations formed on surfaces of the piston and the pressure device, facing each other.

4. The system of claim 2, wherein the gear assembly is integrally formed with the pressure device.

5. A rotary coupling for an all-wheel drive transmission system, comprising:
a clutch disposed between an input member and an output member;
a piston acting on said clutch for engagement thereof, the piston including a piston pressure surface opposite the clutch with at least one indentation formed therein;
a pressure member facing said piston pressure surface with at least one corresponding indentation formed therein;
a spherical member disposed in said indentations between said piston pressure surface and pressure member; and
a rotatable control assembly cooperating with said pressure member for rotation thereof in response to a control signal,
wherein rotation of said pressure member forces said spherical member out of the piston pressure surface indentation whereby force is applied to the piston to engage said clutch.

6. The rotary coupling of claim 5, wherein said rotatable control assembly includes a driven gear acting on the pressure member and a pinion gear driven by a motor cooperating with the driven gear.

7. The rotary coupling of claim 5, wherein said indentations are tangentially formed.

8. The rotary coupling of claim 5, wherein the clutch is a multi-plate clutch.
